(19) United States
(12) Patent Application Publication
(10) Pub. No.: US 2023/0234161 A1
(43) Pub. Date: Jul. 27, 2023

(54) JOINING METHOD AND JOINING MACHINE

(71) Applicant: UL TEX CORPORATION, Fukuoka-shi, Fukuoka (JP)

(72) Inventor: Shigeru SATO, Fukuoka-shi, Fukuoka (JP)

(21) Appl. No.: 18/001,903

(22) PCT Filed: Jun. 30, 2021
(86) PCT No.: PCT/JP2021/024682

§ 371 Date: Dec. 15, 2022

(30) Foreign Application Priority Data
Jun. 30, 2020 (JP) 2020-112393

(51) Int. Cl. B23K 20/10; B23K 20/227

(52) U.S. Cl. CPC B23K 20/10; B23K 20/2275; B23K 2103/04

(57) ABSTRACT

A joining method, etc., is provided, suitable for providing improved joining giving attention to the relation between a horn part and a joining member group. A joining machine performs joining of the joining member group (a first joining member and a second joining member). A horn part of a joining processing part applies sound vibration and/or ultrasound vibration to the joining member group via a buffer member. The horn part and the first joining member are each formed of metal. The buffer member has a greater softness than that of the metal that forms the horn part.

### TECHNICAL FIELD

The present invention relates to a joining method and joining machine, and particularly to a joining method etc., for performing joining of a joining member group.

### BACKGROUND ART

The present applicant has proposed an arrangement in which at least a part of multiple metal members are provided with a protrusion so as to allow energy to be concentrated using sound vibration or ultrasound vibration (see Patent document 1).

Furthermore, the present applicant has also proposed an arrangement in which a horn is supported at multiple portions, and sound vibration and/or ultrasound vibration is supplied to the horn from multiple directions, thereby enabling high-energy joining (see Patent documents 2 and 3).

It should be noted that the contents of Patent documents 1, 2, and 3 are incorporated in the present specification.

### CITATION LIST

### Patent Literature

### [Patent Document 1]

Japanese Patent Application No. 2019-026976

### [Patent Document 2]

Japanese Patent Application No. 2019-229190

### [Patent Document 3]

Japanese Patent Application No. 2020-012556

### SUMMARY OF INVENTION

### Technical Problem

However, with joining processing using high energy, such an arrangement involves new problems between the horn part and the joining member group. For example, in some cases, this leads to the occurrence of damage to the horn, and in some cases, such an arrangement involves poor transmission efficiency of sound energy.

Accordingly, it is a purpose of the present invention to provide a joining method, etc., suitable for improvement of joining processing directing attention to the relation between the horn part and the joining member group.

### Solution of Problem

A first aspect of the preset invention relates to a joining method for joining a joining member group including multiple joining members. The joining method includes joining in which a horn part provided in the joining machine applies sound vibration and/or ultrasound vibration to the joining member group so as to join the joining member group. In the joining, the horn part applies the sound vibration and/or ultrasound vibration to the joining member group via a buffer member having a greater softness than that of the horn part.

A second aspect of the present invention relates to the joining method according to the first aspect. In the joining, the temperature of the buffer member becomes higher than the melting temperature.

A third aspect of the present invention relates to the joining method according to the first or second aspect. In the joining, the temperature of one of the joining members becomes higher than that of the buffer member and at least one other joining member.

A fourth aspect of the present invention relates to the joining method according to any one of the first aspect through the third aspect. At least one from among the buffer member and the joining members is provided with a protrusion on a contact face thereof to be pressed in contact with another member.

A fifth aspect of the present invention relates to the joining method according to any one of the first aspect through the fourth aspect. At least one from among the buffer member and the joining members is provided with a recessed groove structure on a contact face thereof to be pressed in contact with another member.

A sixth aspect of the present invention relates to the joining method according to any one of the first aspect through the third aspect. The buffer member and the joining members are each configured as a flat plate member.

A seventh aspect of the present invention relates to the joining method according to any one of the first aspect through the sixth aspect. Multiple joining members included in the joining member group includes two non-metal members adjacent to each other and at least a metal member between the non-metal member and the horn. In the joining, at least the two adjacent non-metal members are joined.

An eighth aspect of the present invention relates to the joining method according to any one of the first aspect through the seventh aspect. In the joining, the horn part is supported at multiple support positions. A contact portion of the horn part to be pressed in contact with the buffer member is arranged between the multiple support positions.

A ninth aspect of the present invention relates to a joining machine structured to join a joining member group including multiple joining members. The joining machine includes a horn part structured to apply sound vibration and/or ultrasound vibration to the joining member group. The horn part applies the sound vibration and/or ultrasound vibration to the joining member group via a buffer member having a greater softness than that of the horn part.

A tenth aspect of the present invention relates to the joining machine according to the ninth aspect. The temperature of the buffer member becomes higher than the melting temperature.

An eleventh aspect of the present invention relates to the joining machine according to the ninth or tenth aspect. The temperature of one of the joining members becomes higher than that of the buffer member and the other joining members.

A twelfth aspect of the present invention relates to the joining machine according to any one of the ninth aspect through the eleventh aspect. At least one from among the buffer member and the joining members is provided with a protrusion on a contact face thereof to be pressed in contact with another member.

A thirteenth aspect of the present invention relates to the joining machine according to any one of the ninth aspect through the twelfth aspect. At least one from among the buffer member and the joining members is provided with a recessed groove structure on a contact face thereof to be pressed in contact with another member.

A fourteenth aspect of the present invention relates to the joining machine according to any one of the ninth aspect through the thirteenth aspect. The buffer member and the joining members are each configured as a flat plate member.

A fifth aspect of the present invention relates to the joining machine according to any one of the ninth aspect through the fourteenth aspect. Multiple joining members included in the joining member group includes two non-metal members adjacent to each other and at least a metal member between the non-metal member and the horn. In the joining, at least the two adjacent non-metal members are joined.

A sixteenth aspect of the present invention relates to the joining machine according to any one of the ninth aspect through the fifteenth aspect. In the joining processing part, the horn part is supported at multiple support positions. A contact portion of the horn part to be pressed in contact with the buffer member is arranged between the multiple support positions.

It should be noted that the present invention may also be provided as a program for controlling a computer for controlling a joining machine configured to provide joining processing using sound vibration and/or ultrasound vibration so as to realize each aspect of the present invention, or a computer-readable recording medium for recording the program.

Also, the present invention may also be viewed as preventing oxidation by performing the joining in a nitrogen atmosphere.

### Advantageous Effects of Invention

With each aspect of the present invention in which the buffer member is employed, this is capable of protecting the horn part and the joining members from damage, thereby providing improved joining.

### BRIEF DESCRIPTION OF DRAWINGS

FIG. 1 is (a) a block diagram showing an example configuration of a joining machine 1 according to an embodiment of the present invention, (b) a flowchart showing an operation example, and (c) a diagram for specifically explaining the operation.

FIG. 2 is a first diagram for explaining the outline of the present invention.

FIG. 3 is a second diagram for explaining the outline of the present invention.

FIG. 4 is a first diagram for explaining the experimental results of the present invention.

FIG. 5 is a second diagram for explaining the experimental results of the present invention.

FIG. 6 is a third diagram for explaining the experimental results of the present invention.

FIG. 7 is a diagram for explaining an example of joining ceramic superconducting materials.

### DESCRIPTION OF EMBODIMENTS

Description will be made below with reference to the drawings regarding examples of the present invention. It should be noted that the embodiments of the present invention are by no means intended to restrict the present invention to the examples described below.

### Examples

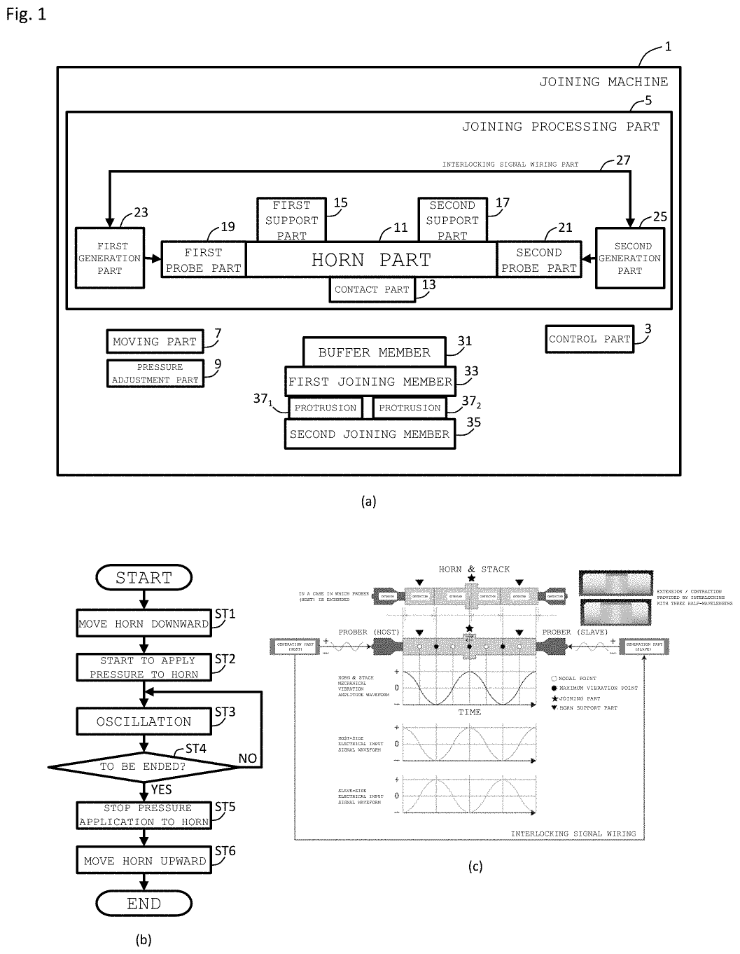

FIG. 1A is a block diagram showing an example configuration of a joining machine 1 according to an embodiment of the present invention. FIG. 1B is a flowchart showing an example of the operation. FIG. 1C is a diagram for specifically explaining the operation.

Referring to FIG. 1A, the joining machine 1 includes a control part 3, a joining processing part 5, a moving part 7, and a pressure adjustment part 9. The joining processing part 5 includes a horn part 11, a first support part 15, a second support part 17, a first probe part 19, a second probe part 21, a first generation part 23, a second generation part 25, and an interlocking signal wiring part 27. The horn part 11 includes a contact part 13.

The joining processing part 5 performs joining of the first joining member 33 and the second joining member 35 (an example of a “joining member group” in the present claims). The first joining member 33 is positioned above the second joining member 35, and is positioned closer to the joining processing part 5. The second joining member 35 is provided with protrusions 37₁ and 37₂ on a contact face thereof to be pressed in contact with the first joining member 33. This allows EC (Energy Concentration) protrusion joining to be provided (see Patent document 1). Furthermore, a buffer member 31 (an example of a “buffer member” in the present claims) is provided between the first joining member 33 and the joining processing part 5.

For example, the horn part 11 is formed of a metal material (e.g., steel). The first joining member 33 is formed of a metal material (e.g., steel, high tensile strength steel, etc.). The second joining member 35 is formed of a metal material (e.g., aluminum, steel, high tensile strength steel, etc.) or a non-metal material (ceramic, etc.). The buffer member 31 is formed of a metal material (aluminum or the like).

The control part 3 is capable of controlling the operation of the joining machine 1 using a control signal. The moving part 7 controls the up-and-down movement of the horn part 11. When the horn part 11 is moved downward, the contact part 13 is pressed in contact with the buffer member 31. The pressure adjustment part 9 adjusts the pressure applied by the contact part 13.

The joining processing part 5 performs joining of the first joining member 33 and the second joining member 35 using sound vibration (vibration that is lower than 20 kHz) and/or ultrasound vibration (vibration that is equal to or higher than 20 kHz).

In the joining processing part 5, the first generation part 23 and the second generation part 25 oscillate an electrical signal that corresponds to the sound vibration and/or ultrasound vibration using the interlocking signal wiring part 27. The first probe part 19 and the second probe part 21 convert the electrical signals generated by the first generation part 23 and the second generation part 25, respectively, into mechanical vibrations. Furthermore, the first probe part 19 and the second probe part 21 transmit the mechanical vibrations thus converted to the horn part 11. The horn part 11 is supported by the first support part 15 and the second support part 17 such that they resonate. This allows the joining processing part 5 to provide joining processing using sound vibration and/or ultrasound vibration.

FIG. 1B is a flowchart showing an example of the operation of the joining machine 1. The moving part 7 moves the horn part 11 downward such that the contact part 13 comes in contact with the buffer member 31 (Step ST1). The pressure adjustment part 9 starts to apply pressure to the buffer member 31, the first joining member 33, and the second joining member 35 via the contact part 13 (Step ST2). The joining processing part 5 vibrates the horn part 11 (Step ST3). The joining processing part 5 judges whether or not the vibration is to be ended (Step ST4). When the vibration is not to be ended, the processing in Step ST3 is continued. When the vibration is to be ended, the joining processing part 5 ends the vibration of the horn 11. Furthermore, the pressure adjustment part 9 stops the application of pressure via the contact part 13 (Step ST5). Subsequently, the moving part 7 moves the horn upward (Step ST6).

FIG. 1C is a diagram for explaining an example of vibration of the horn part 11. The horn part 11 generates vibration with multiple nodal points (portions where the amplitude becomes the minimum) and portions where the amplitude becomes the maximum at positions each of which is interposed between nodal points. The first support part 15 and the second support part 17 are arranged at nodal points. The contact part 13 is arranged such that it comes in contact with a portion at which the vibration becomes the maximum. FIG. 1C shows an example in which the horn part 11 generates vibration with an even number of (four) nodal points. The first generation part 23 and the second generation part 25 oscillate electrical signals with opposite phases using the interlocking signal wiring part 27. With this, an elongation state and a contraction state alternately occur at each nodal point. As described above, the joining processing part 5 is capable of joining the first joining member 33 and the second joining member 35 using sound vibration and/or ultrasound vibration.

In the joining processing provided by the joining processing part 5, the first joining member 33 and the second joining member 35 are joined via the buffer member 31.

The buffer member 31 is formed of a material having a melting temperature that is lower than that of the metal of the horn part 11 and that of the first joining member 33 and/of is formed of a material having a greater softness than that of the horn part 11 (e.g., a material having a low hardness).

For example, in a case in which the horn part 11 is formed of steel, the first joining member 33 is formed of high tensile strength steel, and the second joining member 35 is formed of aluminum (e.g., an extrusion-molded aluminum member or the like), and the buffer member 31 is formed of aluminum. In particular, aluminum has unique characteristics from the material viewpoint. Aluminum has a wide range of uses, and can be effectively employed in the semiconductor field.

In this example, if the first joining member 33 (high tensile strength steel) and the second joining member 35 (aluminum) are joined by means of the horn part 11 (steel) without using the buffer member 31, the horn part 11 (steel) will not readily bite the first joining member 33 (high tensile strength steel). Furthermore, such an arrangement involves degradation of the sound energy transmission efficiency. In contrast, the horn part 11 (steel) has high sound energy transmission efficiency with respect to the buffer member 31 (aluminum). By employing the buffer member 31 (aluminum), first, joining advances between the buffer member 31 (aluminum) and the first joining member 33 (high tensile strength steel). Subsequently, the sound energy transmission efficiency increases between the horn part 11 (steel) and the first joining member 33 (high tensile strength steel) due to the high sound energy transmission efficiency between the horn part 11 (steel) and the buffer member 31 (aluminum).

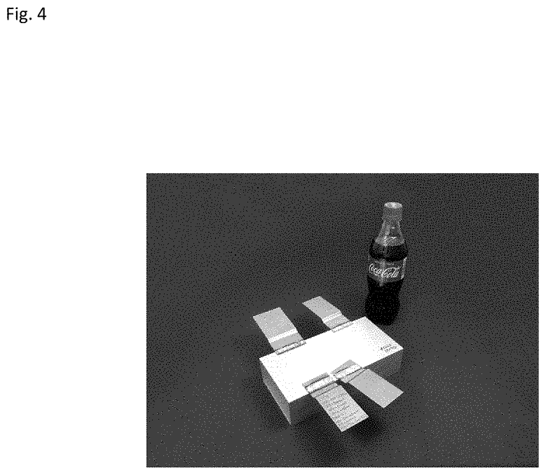

Steel has a melting temperature of 1300° C. or more, and aluminum has a melting temperature of approximately 660° C. The joining processing part 5 excites atoms of the first joining member 33 (high tensile strength steel) using sound energy so as to raise the temperature of the first joining member 33 to a temperature that is equal to or higher than the melting temperature of the buffer member 31 (aluminum), i.e., 660° C. giving consideration to the difference in the melting temperature between them. In this processing, heat is not applied from the exterior. That is to say, the first joining member 33 itself generates heat from its interior. Such a phenomenon can be confirmed from the fact that the temperature of the high tensile strength steel becomes high, i.e., the high tensile strength steel burns (see FIGS. 4 to 6). With this, the first joining member 33 (high tensile strength steel) and the second joining member 35 (aluminum) are joined. This provides the occurrence of melting in the second joining member 35. Furthermore, a diffusion layer (alloy) is formed as an interface between the first joining member 33 and the second joining member 35. At the same time, this increases the strength between the buffer member 31 (aluminum) and the first joining member 33 (high tensile strength steel). Furthermore, melting occurs in the buffer member 31, which thus protrudes in the form of melted burrs. The joining strength can be estimated by confirming such a state by visual checking or the like.

Accordingly, the horn part 11 (steel) has high durability with respect to aluminum. That is to say, this has a low potential to involve the occurrence of burning, abrasion, etc. This allows the cost to be reduced. As described above, with such an arrangement in which the buffer member 31 is designed to have a melting temperature that is lower than that of the horn part 11 and/or is designed to have a greater softness than that of the horn part 11, such an arrangement protects the horn from damage (burning, abrasion, etc.), thereby providing improved practical use.

Stainless steel and ceramic are joined in the same manner. For example, in a case in which the horn part 11 is formed of steel, the first joining member 33 is formed of stainless steel, and the second joining member 35 is formed of ceramic, the buffer member 31 is formed of aluminum. By exciting atoms until the stainless steel is heated to bright red, this allows the joining members to be instantly joined. In this stage, melting occurs in the buffer member 31, which thus protrudes in the form of melted burrs. The joining strength can be estimated by observing such a state by visual checking or the like. Also, such an arrangement is capable of protecting the horn from damage (burning, abrasion, etc.).

As described above, with such an arrangement employing the buffer member 31, this enables a steel member to be joined with another steel member using sound joining. Also, joining of different materials becomes possible, such as a pairing of steel and a metal that differs from steel, a pairing of steel and ceramic, etc.

In particular, EC (Energy Concentration) protrusion joining is effectively used for joining a pairing of steel members and for joining a pairing of a steel member and a different metal member. Steel has high hardness, and has a melting temperature of 1000° C. or higher. In EC protrusion joining, at least one from among the buffer member and the joining members is provided with protrusions on a contact face thereof to be pressed in contact with another member. With this, sound energy is concentrated so as to provide machining (see Patent document 1). For example, in a case in which joining of materials having high hardness and a large difference in melting temperature, such as, for example, high tensile strength steel and aluminum A7075, A6063, A5052, etc., is performed, EC protrusion joining is effectively employed with a groove-formed contact face to be pressed in contact with another member.

As the protrusions to be used in the EC protrusion joining, the buffer member 31 may be provided with such protrusions on its contact face to be pressed in contact with the first joining member 33, for example. Also, the first joining member 33 may be provided with such protrusions on its contact face to be pressed in contact with the buffer member 31 and/or on its contact face to be pressed in contact with the second joining member 35, for example. Also, the second joining member 35 may be provided with such protrusions on its contact face to be pressed in contact with the first joining member 33. FIG. 1 shows an arrangement in which the face of the second joining member 35 that is opposite to the contact face thereof is punched so as to form the protrusions 37₁ and 37₂. By concentrating sound energy using the protrusions 37₁ and 37₂, this enables the generation of self-heating at 660° C. or higher in an atomic excitation state.

With the present invention, this enables both diffusion joining without melting and melting joining using sound vibration (vibration at a frequency that is lower than 20 kHz, e.g., 15 kHz). Furthermore, by employing a WPS (Double Power System, having a double support structure that is capable of providing output that is double the output of a joining machine employing DSS) as shown in FIG. 1, such an arrangement is capable of providing large output to be provided in a low-pressure state using sound vibration, e.g., an output of 10,000 W at a frequency of 15 kHz. Such large output allows various kinds of materials to be joined over a wide range of materials from aluminum, having a low melting temperature, to iron and ceramic, having a high melting temperature.

The present invention is applicable to an arrangement in which the buffer member and/or the joining member is structured as a flat plate member (without protrusions or the like).

As described above, the buffer member 31 is soft and can be easily joined with another member. This allows the horn part 11 and the first joining member 33 to be protected from damage. Furthermore, the horn part 11 is directly pressed into contact with the buffer member 31. Moreover, the buffer member 31 is joined with the first joining member 33 before the first joining member 33 and the second joining member 35 are joined. This allows sound energy to be transmitted with improved efficiency from the horn part 11 to the first joining member 33, thereby allowing a steel member to be joined with another steel member, for example.

With the present invention, this allows various kinds of materials including steel to be joined over a wide range of materials (e.g., a pairing of steel members, a pairing of a steel member and a different metal member, a pairing of a steel member and a non-metal member, a pairing of a steel member and a ceramic member, etc.). Furthermore, this allows the joining strength to be improved. Moreover, this allows each material to be joined by melting. This dramatically widens the range of applications using sound joining and dramatically raises the scale, thereby changing the known potential of sound energy. Furthermore, this allows the equipment installation cost to be reduced. Moreover, this allows the horn to have a long operating life. Accordingly, this allows the consumable costs to be reduced. Moreover, this allows the joining process to be designed in a simple manner. In addition, this contributes to environmental issues and energy conservation.

It should be noted that description has been made with reference to FIG. 1 regarding an example in which two probe parts are provided. Also, in the present invention, the number of probe parts may be one or three or more.

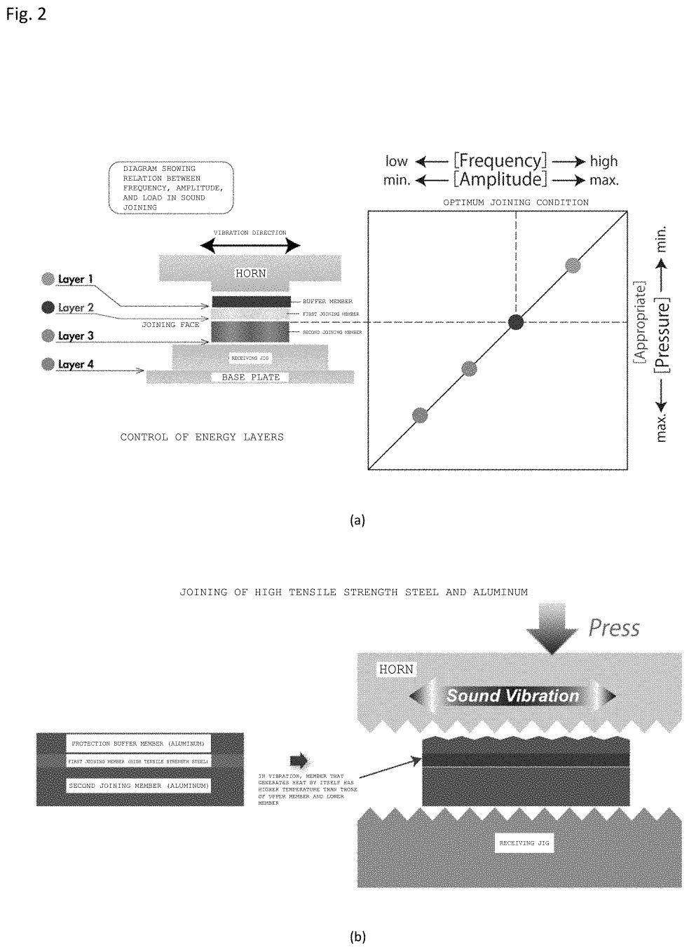

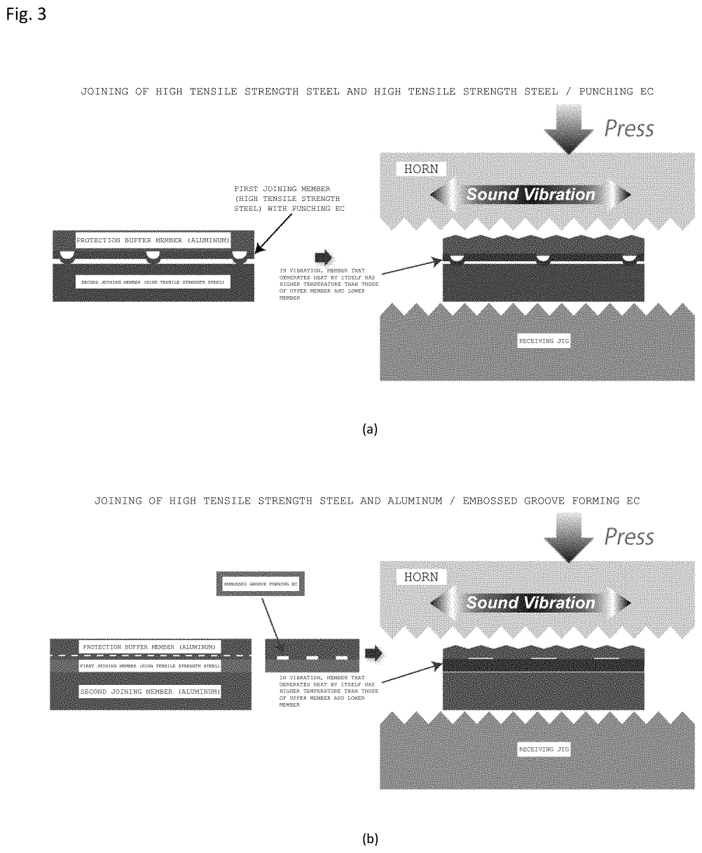

FIGS. 2 and 3 are diagrams for explaining the outline of the present invention.

Referring to FIG. 2A, description will be made regarding the relation between the frequency, amplitude, and load in sound joining. The horn, buffer member, first joining member, second joining member, receiving jig, and base plate are arranged in this order from the top. The horn is vibrated in the horizontal direction. There are four energy layers, i.e., a layer (layer 1) between the buffer member and the first joining member, a layer (contact face or layer 2) between the first joining member and the second joining member, a layer (layer 3) between the second joining member and the receiving jig, and a layer (layer 4) between the receiving jig and the base plate. There is a need to control the energy layers, i.e., the layers 1, 2, 3, and 4. Typically, in a case in which the sound joining is performed at a low frequency and with a small amplitude, the load is increased. Conversely, in a case in which the sound joining is performed at a high frequency and with a large amplitude, the load is reduced. Optimal joining conditions must be designed for the layers 1 through 4 with respect to the frequency, amplitude, and load.

Referring to FIG. 2B, in a case of joining a high tensile strength steel member (first joining member) and an aluminum member (second joining member), for example, an aluminum member is employed as the buffer member so as to provide joining processing. In the application of vibration, the high tensile strength steel member (first joining member) itself generates heat and becomes a higher temperature than the members above and below the high tensile strength steel member, thereby providing the joining processing.

Referring to FIG. 3A, in a case of joining a high tensile strength steel member (first joining member) and another high tensile strength steel member (second joining member), for example, an aluminum member is employed as the buffer member so as to provide joining processing using EC protrusion joining. In this example shown in FIG. 3A, the high tensile strength steel member (first joining member) is provided with protrusions on the joining face side for joining with the other high tensile strength steel member (second joining member). In the example shown in FIG. 3A, one face of the first joining member is punched using a rod-shaped member so as to form protrusions on the opposite face side (punching EC).

Referring to FIG. 3B, in a case of joining a high tensile strength steel member (first joining member) and an aluminum member (second joining member), for example, an aluminum member is employed as the buffer member so as to provide joining processing using EC protrusion joining. In this example shown in FIG. 3B, an embossed groove structure is formed in the buffer member (aluminum) on the joining face side thereof to be joined with the high tensile strength steel member (first joining member) so as to form protrusions (embossed groove forming EC).

FIG. 4 is a diagram showing an example of joining of a high tensile strength steel member (first joining member) and an aluminum member (second joining member) using an aluminum member as a buffer member. In the first stage, joining was performed with a load of 2500 N, R/T=3000 ms, W/T=5.000 s, and amplitude Amp.=46 mm. In the second stage, joining was performed with a load of 2500 N, R/T=3000 ms, W/T=7.000 s, and amplitude Amp.=52 mm.

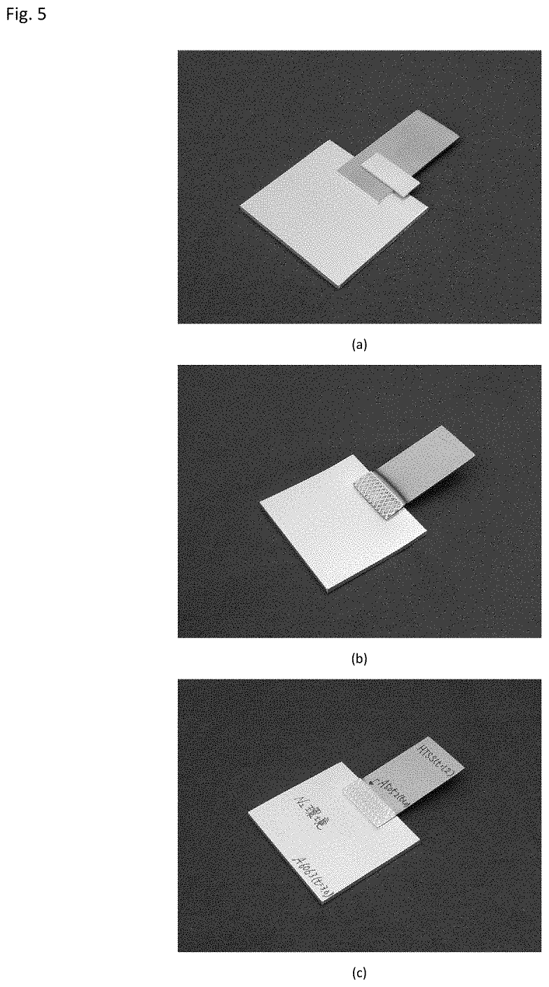

FIG. 5 shows an example of joining of a high tensile strength steel member (HISS, thickness t=1.2) as the first joining member and an aluminum member (A6063, thickness t=3.0) as the second joining member using an aluminum member (A5052, thickness t=1.0) as a buffer member.

FIG. 5A shows a state before joining. FIG. 5B shows a state after joining. FIG. 5C shows a state subjected to joining under a nitrogen atmosphere (N₂ environment), which provides fine joining almost without oxidation as compared with that shown in FIG. 5B.

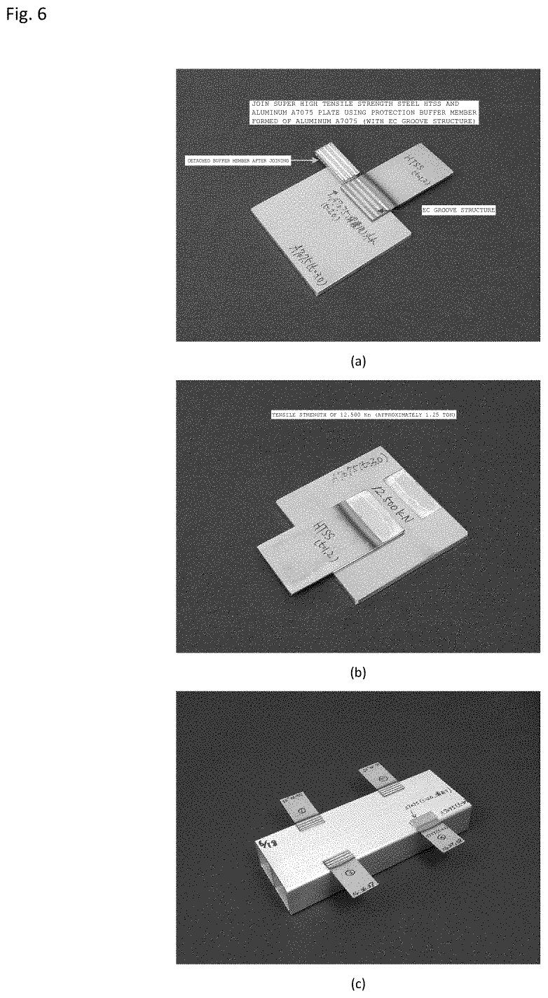

FIG. 6 shows experimental results provided by embossed groove forming EC. FIGS. 6A and 6B each show an arrangement in which, as a protection member, an aluminum A7075 member is provided with a thickness t=2.0 mm, and an embossed groove structure is formed on the contact face of the protection member to be pressed in contact with the first joining member. The first joining member is configured as a high tensile strength steel member (HISS, thickness t=1.2 mm), and the second joining member is configured as an aluminum member (A7075, thickness t=3.0 mm). FIG. 6A shows a state in which the buffer member is detached after the joining. FIG. 6B shows the experimental results provided by a tensile test. A tensile strength of 12.500 kN (approximately 1.25 ton) was obtained.

FIG. 6C shows an example in which the first joining member (high tensile strength steel member, HISS, thickness t=1.2 mm) is joined with the second joining member (aluminum, A7075, thickness t=3.0 mm) configured as an extrusion-formed product member. The protection member is configured as an aluminum A7075 member with a thickness t=2.0 mm. An embossment groove structure is formed on the contact face of the protection member to be pressed in contact with the first joining member. That is to say, recessed grooves are formed.

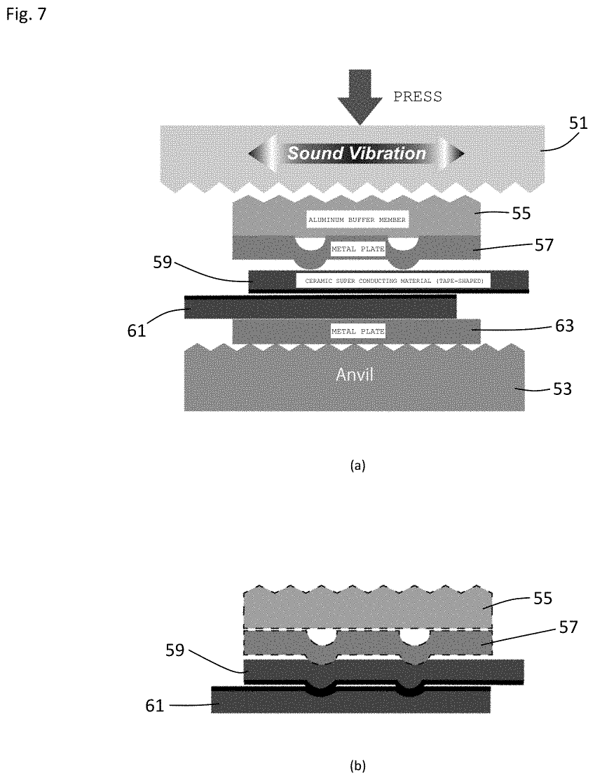

FIG. 7 is a diagram for explaining joining of ceramic superconducting materials. Referring to FIG. 7A, an aluminum buffer member 55 and a joining member group are arranged between a horn 51 and an anvil 53. The joining member group is formed of a first metal plate 57, a first ceramic superconducting material 59, a second ceramic superconducting material 61, and a second metal plate 63 arranged in this order from the top. The first metal plate 57 and the second metal plate 63 are each formed of steel, for example. The first metal plate 57 is formed with EC, with protrusions formed such that they extend downward. The aluminum buffer member 55 has a melting temperature that is lower than that of the metal plate. The first ceramic superconducting material 59 and the second ceramic superconducting material 61 are each configured as a tape-shaped member, and are arranged such that the ceramic face of one ceramic superconducting material is pressed in contact with the ceramic face of the other ceramic superconducting material.

One-shot joining is performed at, for example, 20 kHz using the horn 51. FIG. 7B shows an example of the joined state. The first ceramic superconducting material 59 and the second ceramic superconducting material 61 are joined by momentarily raising the temperature of the first metal plate 57 and/or the second metal late 63 to a high temperature. Each joining layer can be controlled by adjusting the joining conditions of the joining machine.

The purpose is the joining of the first ceramic superconducting material 59 and the second ceramic superconducting material 61. Accordingly, there is no problem regardless of whether or not the aluminum buffer member 55, the first metal plate 57, and the second metal plate 63 are joined.

### REFERENCE SIGNS LIST

1 joining machine, 3 control part, 5 joining processing part, 7 moving part, 9 pressure adjustment part, 11 horn part, 13 contact part, 15 first support part, 17 second support part, 19 first probe part, 21 second probe part, 23 first generation part, 25 second generation part, 27 interlocking signal wiring part, 31 buffer member, 33 first joining member, 35 second joining member, 51 horn, 53 anvil, 55 aluminum buffer member, 57 first metal plate, 59 first ceramic superconducting material, 61 second ceramic superconducting material, 63 second metal plate.

1-9. (canceled)

10. A joining method for joining a joining member group comprising a plurality of joining members,
wherein the joining method comprises joining in which a horn part provided in the joining machine applies sound vibration and/or ultrasound vibration to the joining member group so as to join the joining member group,
wherein, in the joining, the horn part applies the sound vibration and/or ultrasound vibration to the joining member group via a buffer member having a greater softness than that of the horn part,
wherein the joining member group includes a first joining member that is closest to the horn part and a second joining member adjacent to the first joining member,
wherein the buffer member and the first joining member are each configured as a metal member,
and wherein the first joining member and the second joining member are joined with an improvement in transmission efficiency with respect to sound energy transmitted by the horn part to the first joining member as compared with an arrangement without including the buffer member.

11. The joining method according to claim 10, wherein the first joining member is configured as a high tensile strength steel member.

12. The joining method according to claim 10, wherein the buffer member is configured as an aluminum member.

13. The joining method according to claim 10, wherein, in the joining, a temperature of the buffer member becomes higher than a melting temperature.

14. The joining method according to claim 10, wherein, in the joining, a temperature of one of the joining members becomes higher than that of the buffer member and at least one other joining member.

15. The joining method according to claim 10, wherein at least one from among the buffer member and the joining members is provided with a protrusion on a contact face with another member.

16. The joining method according to claim 10, wherein at least one from among the buffer member and the joining members is provided with a recessed groove structure on a contact face with another member.

17. The joining method according to claim 10, wherein the buffer member and the joining members are each configured as a flat plate member.

18. The joining method according to claim 10, wherein a plurality of joining members included in the joining member group includes two non-metal members adjacent to each other and at least a metal member between the non-metal member and the horn part,
and wherein, in the joining, at least the two adjacent non-metal members are joined.

19. The joining method according to claim 10, wherein, in the joining, the horn part is supported at a plurality of support positions,
and wherein a contact portion of the horn part to be pressed in contact with the buffer member is arranged between the plurality of support positions.

20. A joining machine configured to join a joining member group including a plurality of joining members, comprising a horn part configured to apply sound vibration and/or ultrasound vibration to the joining member group,
wherein the horn part applies the sound vibration and/or ultrasound vibration to the joining member group via a buffer member having a greater softness than that of the horn part,
wherein the joining member group includes a first joining member that is closest to the horn part and a second joining member adjacent to the first joining member,
wherein the buffer member and the first joining member are each configured as a metal member,
and wherein the first joining member and the second joining member are joined with an improvement in transmission efficiency with respect to sound energy transmitted by the horn part to the first joining member as compared with an arrangement without including the buffer member.

21. The joining machine according to claim 20, wherein the first joining member is configured as a high tensile strength steel member, and/or the buffer member is configured as an aluminum member.

22. The joining machine according to claim 20, wherein a temperature of the buffer member becomes higher than a melting temperature, and/or a temperature of one of the joining members becomes higher than that of the buffer member and at least one other joining member.

23. The joining machine according to claim 20, wherein at least one from among the buffer member and the joining members is provided with a protrusion and/or a recessed groove structure on a contact face with another member.

24. The joining machine according to claim 20, wherein a plurality of joining members included in the joining member group includes two non-metal members adjacent to each other and at least a metal member between the non-metal member and the horn part,
and wherein at least the two adjacent non-metal members are joined.
